(19) United States
(12) Patent Application Publication
(10) Pub. No.: US 2014/0322348 A1
(43) Pub. Date: Oct. 30, 2014

(54) COMBINATIONS OF ANTIFUNGAL COMPOUNDS AND TEA TREE OIL

(71) Applicant: Stockton (Israel) Ltd., Petach-Tikva (IL)

(72) Inventor: Moshe Reuveni, Katzrin (IL)

(21) Appl. No.: 14/356,887

(22) PCT Filed: Nov. 8, 2012
(86) PCT No.: PCT/IB2012/056260

§ 371 Date: May 8, 2014

Related U.S. Application Data
(60) Provisional application No. 61/557,858, filed on Nov. 9, 2011.

(51) Int. Cl. A01N 65/28; A01N 43/54; A01N 59/26

(52) U.S. Cl. CPC A01N 65/28; A01N 59/26; A01N 43/54
USPC 424/605; 424/725

(57) ABSTRACT

There is disclosed a method for treating a plant infection caused by a fungus of the class oomycetes, comprising applying to the plant a combination of tea tree oil (TTO) and a synthetic fungicidal compound. Other embodiments are also disclosed.

### RELATED APPLICATIONS

This application claims priority from U.S. provisional application No. 61/557,858, filed Nov. 9, 2011 and entitled “Combinations of Antifungal Compounds and Tea Tree Oil”. The contents of this application are incorporated herein by reference.

### BACKGROUND

Infection of crops by fungi and by oomycetes (which many people no longer classify as fungi, but which may be controlled with fungicides) is a well-documented problem that can significantly affect crop yields. Various treatments of fungi by synthetic (chemical) products (including both curative and prophylactic treatments) have been developed, but they present problems as well. One problem, for example, is the effect of the so-called chemical load on the environment, animal and human health, and food safety. For these and other reasons, the popularity of “organic” or “bio-” fungicides, i.e. those derived from natural sources, has increased in recent years.

An additional problem encountered with the use of synthetic antifungal compounds, noticed by the early 1970's, is that resistance to such antifungal compounds sometimes develops. For example, the classes of antifungal compounds known as DMIs and strobilurins (discussed below) are biochemically active on a specific target site, and their broad use has led to fungal strains becoming less sensitive to other members of these classes of compounds. In response, various methods for countering such resistance when it occurs, or for reducing the likelihood of such resistance even developing, have been developed to enable continued use of synthetic fungicidal compounds when possible. These methods, also called “resistance management strategies”, include, among other steps, the simultaneous or sequential use of combinations of synthetic antifungal compounds that have different modes of action, limiting the number of uses of a particular antifungal compound during a giving growing season, and applying a given antifungal at a dosage that equals or exceed a particular minimum dosage. See, e.g. Keith J. Brent and Derek W. Hollomon, “Fungicide Resistance in Crop Pathogens: How Can it Be Managed?”, 2^{nd}, revised edition, 2007, Fungicide Resistance Action Committee (FRAC), Croplife International, Avenue Louise 143, 1050 Brussels, Belgium, available online at http://www.frac.info/frac/publication/anhang/FRAC Monol 2007 100 dpi.pdf, or “FRAC recommendations for fungicide mixtures designed to delay resistance evolution” (http://www.frac.info/frac/publication/anhang/Resistance%20and%20Mixtures%20Jan2010_ff.pdf) (see e.g. the statement at page 2 that “A key requirement for any mixture product applied to manage resistance is that the components of the mixture must not be cross-resistant and the dose rates of each component used in the mixture should provide sufficient control of sensitive isolates when used alone.”).

In addition to combining fungicides in order to delay or reduce the emergence of resistant strains, fungicides are also often combined in mixtures in order to widen the spectrum and extend the duration of antifungal activity; and to exploit synergistic interaction between the active fungicidal compounds, whereby the overall activity can be increased. Synergy, which is a frequent phenomenon in fungicide mixtures, may occur between antifungal compounds of different natures and sources, between fungicides with different or identical modes of action, and between those prepared in different formulations.

While in principle combinations of synthetic antifungal compounds could be used to reduce the chemical load of any particular synthetic antifungal compound applied to crops, the fear of resistance at such lower loads has mitigated against the use of such lower loads, as reflected in the FRAC papers referenced above.

In the case of downy mildews in particular, e.g. Pseudoperonospora cubensis (Cucurbits downy mildew) or Plasmopara viticola (grapevine downy mildew), which are fungi of the order of Peronosporales of the class oomycetes, fungicidal resistance to PhenylAmides (PAs), Quinone outside Inhibitors (QoIs), Polyoxins, and Cyanoacetamide oximes is a known problem (see e.g. “FRAC List of Plant Pathogenic Organisms Resistant to Disease Control Agents”, available at http://www.frac.info/frac/publication/anhang/List%20of%20resistant%20plant%20pathogens_Jan%202011.pdf, published by FRAC, January 2011). Currently, chemical treatment of such fungi is effected using one or a mixture of synthetic fungicidal compounds, which can be categorized into several major groups (although some fungicidal compounds used do not fall into one of these groups): (a) PhenylAmides (PAs), such as benalaxyl, benalaxyl-M (also known as kiralaxyl), furalaxyl, metalaxyl, oxadixyl and metalaxyl-M (also known as mefenoxam); (b) Quinone outside Inhibitors (QoIs), such as famoxadone and strobilurins such as azoxystrobin, pyraclostrobin, trifloxystrobin, fluoxastrobin, and fenamidone; (c) Polyoxins such as polyoxin B, (d) Cyanoacetamide oximes, such as cymoxanil, (e) Phosphonates (also sometimes referred to as phosphites), e.g. potassium phosphite (KHP(O₂)OH), (f) demethylation inhibitors (DMIs), such as difenoconazole, (g) Carboxylic Acid Amides (CAAs), such as dimethomorph and mandipropamid, (h) Cyanoacetamide-oxime; (i) Dithiocarbamates such as mancozeb; (j) Benzamides such as zoxamide, (k) 2,6-Dinitroanilines such as fluazinam, (l) Carbamates such as propamocarb, (m) Quinone inside Inhibitors (QiIs) such as cyazofamid, (n) Chloronitriles such as chlorothalonil, (o) copper-based products, and (p) organotin compounds such as triphenyltin hydroxide. These compounds are applied to the foliage and roots of plants that are infected or likely to be infected by such fungi, for example by spraying a composition containing one or more of the compounds listed above as the active ingredient(s) on the foliage or on soil in which the susceptible plants are being or will be grown.

As noted above, it is recommended that for a combination of active ingredients to be effective in a resistance management strategy, the rate of application of each active ingredient should be sufficient to provide satisfactory control when used alone at the same rate, and the recommended label rate of each mixture component should be respected. This means that growers do not reduce the dosages of fungicides, even when from a short-term economic and an environmental standpoint it would be desirable to do so, e.g. to reduce expenditures on fungicides or to reduce chemical run-off into the ground.

Emulsions containing tea tree oil (TTO) for fungicidal application to plants, e.g. to plant leaves, are known. See, for example, US Patent Publication No. 2007/0237837, and the commercial product available under the name Timorex Gold from Biomor Israel Ltd., P.O. Box 81, Qatzrin 12900 Israel, http://www.biomor.com/timorex%20gold.htm. Timorex Gold has been successfully applied to combat downy mildew in some plants (see e.g. Reuveni et al., “A new tea tree oil-based organic fungicide for the control of grape powdery and downy mildews”, Phytopathology 2009, abstract from APS meeting 2009), although neither TTO in general nor Timorex Gold in particular appear in the lists of fungicides in FRAC documents. Similarly, Timorex Gold has been used alone to combat oomycetes fungi in other crops.

### BRIEF DESCRIPTION OF EMBODIMENTS OF THE INVENTION

There is provided in accordance with an embodiment of the invention a method for treating a plant infection caused by a member of the class oomycetes, comprising applying to the plant a combination of tea tree oil (TTO) and a synthetic fungicidal compound. In some embodiments, the infection is caused by a member of the group consisting of Phytophthora (e.g. Phytophthora infestans or Phytophthora capsici), Pseudoperonospora (e.g. Pseudoperonospora cubensis), Peronospora (e.g. Peronospora belbahrii), Plasmopara (e.g. Plasmopara viticola) and Pythium. In some embodiments, the infection is caused by an oomycete selected from the group consisting of Pseudoperonospora cubensis (cucumber downy mildew) Plasmopara viticola (grapevine downy mildew), Bremia lactucae (lettuce downy mildew), Peronospora destructor (onion downy mildew), Peronospora viciae (pea downy mildew), Phytophthora infestans (potato blight), and Phytophthora capsici. In some embodiments, the infection is selected from the group consisting of cucumber downy mildew and grapevine downy mildew. In some embodiments, the combination is applied to the leaves of the plant.

In some embodiments, the TTO is applied as a TTO-containing composition. In some embodiments, the TTO-containing composition comprises TTO and an emulsifier. In some embodiments the emulsifier is an alkali metal salt of a C₆-C₂₆ fatty acid, an ammonium salt of a C₆-C₂₆ fatty acid, or a mixture of such salts. In some embodiments the emulsifier is selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates. In some embodiments, the TTO-containing composition is an oil-in-water emulsion. In some embodiments, the TTO is present in the TTO-containing composition in an amount of from 0.01 wt. % to 10 wt. %. In some embodiments, the TTO is present in the TTO-containing composition in an amount of not more than 9 wt. %. In some embodiments, the TTO is present in the TTO-containing composition in an amount of not more than 8 wt. %. In some embodiments, the TTO is present in the TTO-containing composition in an amount of not more than 7 wt. %. In some embodiments, the TTO is present in the TTO-containing composition in an amount of not more than 6 wt. %. In some embodiments, the TTO is present in the TTO-containing composition in an amount of not more than 5 wt. %. In some embodiments, the TTO is present in the TTO-containing composition in an amount of not more than 4 wt. %. In some embodiments, the TTO is present in the TTO-containing composition in an amount of not more than 3 wt. %. In some embodiments, the TTO is present in the TTO-containing composition in an amount of not more than 2 wt. %. In some embodiments, the TTO is present in the TTO-containing composition in an amount of not more than 1 wt. %. In some embodiments, the TTO is present in the TTO-containing composition in an amount of at least 0.02 wt. %. In some embodiments, the TTO is present in the TTO-containing composition in an amount of at least 0.03 wt. %. In some embodiments, the TTO is present in the TTO-containing composition in an amount of at least 0.04 wt. %. In some embodiments, the TTO is present in the TTO-containing composition in an amount of at least 0.05 wt. %. In some embodiments, the TTO is present in the TTO-containing composition in an amount of at least 0.06 wt. %. In some embodiments, the TTO is present in the TTO-containing composition in an amount of at least 0.07 wt. %. In some embodiments, the TTO is present in the TTO-containing composition in an amount of at least 0.08 wt. %. In some embodiments, the TTO is present in the TTO-containing composition in an amount of at least 0.09 wt. %. In some embodiments, the TTO is present in the TTO-containing composition in an amount of at least 0.1 wt. %. In some embodiments, the TTO is present in the TTO-containing composition in an amount of at least 0.2 wt. %. In some embodiments, the TTO is present in the TTO-containing composition in an amount of at least 0.3 wt. %. In some embodiments, the TTO is present in the TTO-containing composition in an amount of at least 0.4 wt. %. In some embodiments, the TTO is present in the TTO-containing composition in an amount of at least 0.5 wt. %. In some embodiments, the TTO is present in the TTO-containing composition in an amount of at least 0.6 wt. %. In some embodiments, the TTO is present in the TTO-containing composition in an amount of at least 0.7 wt. %. In some embodiments, the TTO is present in the TTO-containing composition in an amount of at least 0.8 wt. %. In some embodiments, the TTO is present in the TTO-containing composition in an amount of at least 0.9 wt. %. In some embodiments, the TTO is present in the TTO-containing composition in an amount of at least 1.0 wt. %.

In some embodiments, the TTO-containing composition further comprises an additional etheric oil. In some embodiments, the additional etheric oil is selected from the group consisting of lavender (Lavandula angustifolia) oil, pine (Pinus sylvestris) oil, manuka (Leptosperemum scoparium) oil, kanuca (Kunzea ericoids) oil, eucalyptus (Eucaluptus globules) oil, bergamot (Citrus bergamia) oil, clove (Eugenia caryaphylata) oil, lemon (Citrus limoneum) oil, lemon grass (Cymbpogon citrates) oil, rosemary (Rosmarinus officialis) oil, geranium (Pelargonium graveoleus) oil, and mint oil, the latter of which refers to an etheric oil containing high levels of menthol and/or methane; and mixtures thereof.

In some embodiments, the TTO-containing composition further comprises the synthetic fungicidal compound. In some embodiments, the combination of TTO and synthetic fungicidal compound is applied simultaneously. In some embodiments, the combination of TTO and synthetic fungicidal compound is applied as a single mixture. In some embodiments, the combination of TTO and synthetic fungicidal compound is applied sequentially. In some embodiments, the combination of TTO and synthetic fungicidal compound is applied as separate compositions. In some embodiments, the combination of TTO and synthetic fungicidal compound is applied in conjunction with at least one of a mineral oil and an emulsifier.

In some embodiments, the synthetic fungicidal compound is applied at a dosage rate that is less than the rate indicated by the manufacturer as being the correct dosage rate in the absence of TTO. In some embodiments, the dosage rate at which the synthetic fungicidal compound is applied is not greater than 95% of the correct dosage rate as indicated by the manufacturer in the absence of TTO. In some embodiments, the dosage rate at which the synthetic fungicidal compound is applied is not greater than 90% of the correct dosage rate as indicated by the manufacturer in the absence of TTO. In some embodiments, the dosage rate at which the synthetic fungicidal compound is applied is not greater than 85% of the correct dosage rate as indicated by the manufacturer in the absence of TTO. In some embodiments, the dosage rate at which the synthetic fungicidal compound is applied is not greater than 80% of the correct dosage rate as indicated by the manufacturer in the absence of TTO. In some embodiments, the dosage rate at which the synthetic fungicidal compound is applied is not greater than 75% of the correct dosage rate as indicated by the manufacturer in the absence of TTO. In some embodiments, the dosage rate at which the synthetic fungicidal compound is applied is not greater than 70% of the correct dosage rate as indicated by the manufacturer in the absence of TTO. In some embodiments, the dosage rate at which the synthetic fungicidal compound is applied is not greater than 65% of the correct dosage rate as indicated by the manufacturer in the absence of TTO. In some embodiments, the dosage rate at which the synthetic fungicidal compound is applied is not greater than 60% of the correct dosage rate as indicated by the manufacturer in the absence of TTO. In some embodiments, the dosage rate at which the synthetic fungicidal compound is applied is not greater than 55% of the correct dosage rate as indicated by the manufacturer in the absence of TTO. In some embodiments, the dosage rate at which the synthetic fungicidal compound is applied is not greater than 50% of the correct dosage rate as indicated by the manufacturer in the absence of TTO. In some embodiments, the dosage rate at which the synthetic fungicidal compound is applied is not greater than 45% of the correct dosage rate as indicated by the manufacturer in the absence of TTO. In some embodiments, the dosage rate at which the synthetic fungicidal compound is applied is not greater than 40% of the correct dosage rate as indicated by the manufacturer in the absence of TTO. In some embodiments, the dosage rate at which the synthetic fungicidal compound is applied is not greater than 35% of the correct dosage rate as indicated by the manufacturer in the absence of TTO. In some embodiments, the dosage rate at which the synthetic fungicidal compound is applied is not greater than 30% of the correct dosage rate as indicated by the manufacturer in the absence of TTO. In some embodiments, the dosage rate at which the synthetic fungicidal compound is applied is at least 40% of the correct dosage rate as indicated by the manufacturer in the absence of TTO. In some embodiments, the dosage rate at which the synthetic fungicidal compound is applied is at least 45% of the correct dosage rate as indicated by the manufacturer in the absence of TTO. In some embodiments, the dosage rate at which the synthetic fungicidal compound is applied is at least 50% of the correct dosage rate as indicated by the manufacturer in the absence of TTO. In some embodiments, the dosage rate at which the synthetic fungicidal compound is applied is at least 55% of the correct dosage rate as indicated by the manufacturer in the absence of TTO. In some embodiments, the dosage rate at which the synthetic fungicidal compound is applied is at least 60% of the correct dosage rate as indicated by the manufacturer in the absence of TTO. In some embodiments, the dosage rate at which the synthetic fungicidal compound is applied is at least 65% of the correct dosage rate as indicated by the manufacturer in the absence of TTO. In some embodiments, the dosage rate at which the synthetic fungicidal compound is applied is at least 70% of the correct dosage rate as indicated by the manufacturer in the absence of TTO. In some embodiments, the dosage rate at which the synthetic fungicidal compound is applied is at least 75% of the correct dosage rate as indicated by the manufacturer in the absence of TTO.

In some embodiments, the TTO is applied at a dosage rate that is less than the rate indicated by the manufacturer as the rate used when the TTO is applied in the absence of a synthetic fungicidal compound. In some embodiments, the dosage rate at which the TTO is applied is not greater than 95% of the correct dosage rate as indicated by the manufacturer in the absence of application of a synthetic fungicidal compound. In some embodiments, the dosage rate at which the TTO is applied is not greater than 90% of the correct dosage rate as indicated by the manufacturer in the absence of application of a synthetic fungicidal compound. In some embodiments, the dosage rate at which the TTO is applied is not greater than 85% of the correct dosage rate as indicated by the manufacturer in the absence of application of a synthetic fungicidal compound. In some embodiments, the dosage rate at which the TTO is applied is not greater than 80% of the correct dosage rate as indicated by the manufacturer in the absence of application of a synthetic fungicidal compound. In some embodiments, the dosage rate at which the TTO is applied is not greater than 75% of the correct dosage rate as indicated by the manufacturer in the absence of application of a synthetic fungicidal compound. In some embodiments, the dosage rate at which the TTO is applied is not greater than 70% of the correct dosage rate as indicated by the manufacturer in the absence of application of a synthetic fungicidal compound. In some embodiments, the dosage rate at which the TTO is applied is not greater than 65% of the correct dosage rate as indicated by the manufacturer in the absence of application of a synthetic fungicidal compound. In some embodiments, the dosage rate at which the TTO is applied is not greater than 60% of the correct dosage rate as indicated by the manufacturer in the absence of application of a synthetic fungicidal compound. In some embodiments, the dosage rate at which the TTO is applied is not greater than 55% of the correct dosage rate as indicated by the manufacturer in the absence of application of a synthetic fungicidal compound. In some embodiments, the dosage rate at which the TTO is applied is not greater than 50% of the correct dosage rate as indicated by the manufacturer in the absence of application of a synthetic fungicidal compound. In some embodiments, the dosage rate at which the TTO is applied is not greater than 45% of the correct dosage rate as indicated by the manufacturer in the absence of application of a synthetic fungicidal compound. In some embodiments, the dosage rate at which the TTO is applied is not greater than 40% of the correct dosage rate as indicated by the manufacturer in the absence of application of a synthetic fungicidal compound. In some embodiments, the TTO is applied is not greater than 35% of the correct dosage rate as indicated by the manufacturer in the absence of application of a synthetic fungicidal compound. In some embodiments, the dosage rate at which the TTO is applied is not greater than 30% of the correct dosage rate as indicated by the manufacturer in the absence of application of a synthetic fungicidal compound. In some embodiments, the dosage rate at which the TTO is applied is at least 40% of the correct dosage rate as indicated by the manufacturer in the absence of application of a synthetic fungicidal compound. In some embodiments, the dosage rate at which the TTO is applied is at least 45% of the correct dosage rate as indicated by the manufacturer in the absence of application of a synthetic fungicidal compound. In some embodiments, the dosage rate at which the TTO is applied is at least 50% of the correct dosage rate as indicated by the manufacturer in the absence of application of a synthetic fungicidal compound. In some embodiments, the dosage rate at which the TTO is applied is at least 55% of the correct dosage rate as indicated by the manufacturer in the absence of application of a synthetic fungicidal compound. In some embodiments, the dosage rate at which the TTO is applied is at least 60% of the correct dosage rate as indicated by the manufacturer in the absence of application of a synthetic fungicidal compound. In some embodiments, the dosage rate at which the TTO is applied is at least 65% of the correct dosage rate as indicated by the manufacturer in the absence of application of a synthetic fungicidal compound. In some embodiments, the dosage rate at which the TTO is applied is at least 70% of the correct dosage rate as indicated by the manufacturer in the absence of application of a synthetic fungicidal compound. In some embodiments, the dosage rate at which the TTO composition is applied is at least 75% of the correct dosage rate as indicated by the manufacturer in the absence of application of a synthetic fungicidal compound.

In some embodiments, the synthetic fungicidal compound is selected from the group consisting of (a) PhenylAmides (PAs), such as benalaxyl, benalaxyl-M (also known as kiralaxyl), furalaxyl, metalaxyl, oxadixyl and metalaxyl-M (also known as mefenoxam); (b) Quinone outside Inhibitors (QoIs), such as famoxadone and strobilurins such as azoxystrobin, pyraclostrobin, trifloxystrobin, fluoxastrobin, and fenamidone; (c) Polyoxins, (d) Cyanoacetamide oximes, such as cymoxanil, (e) Phosphonates (also sometimes referred to as phosphites), e.g. potassium phosphite (KHP(O₂)OH), (f) demethylation inhibitors (DMIs), such as difenoconazole, (g) Carboxylic Acid Amides (CAAs), such as dimethomorph and mandipropamid, (h) Cyanoacetamide-oxime; (i) Dithiocarbamates such as mancozeb; (j) Benzamides such as zoxamide, (k) 2,6-Dinitroanilines such as fluazinam, (l) Carbamates such as propamocarb, (m) Quinone inside Inhibitors (QiIs) such as cyazofamid, (n) Chloronitriles such as chlorothalonil, (o) copper-based products, and (p) organotin compounds such as triphenyltin hydroxide.

In some embodiments, the synthetic fungicidal compound is a compound that is indicated for the treatment of cucumber downy mildew, and the combination is applied to at least one cucumber plant. In some embodiments, the synthetic fungicidal compound is selected from the group consisting of phosphorous acid and salts thereof (e.g. potassium phosphite), copper, mefenoxam, chlorothanonil, polymeric manganese ethylene bis(dithiocarbamate), mancozeb, cymoxanil, dimethomorph, zoxamide, propamocarb, cyazofamid, cymoxanil, and famoxadone. In some embodiments, the synthetic fungicidal compound is potassium phosphite or ammonium phosphite.

In some embodiments, the synthetic fungicidal compound is a compound that is indicated for the treatment of grapevine downy mildew, and the combination is applied to at least one grape plant. In some embodiments, the synthetic fungicidal compound is selected from the group consisting of azoxystrobin, mancozeb, captan, copper-containing fungicides, metalaxyl and phosphorous acid and salts thereof (e.g. potassium phosphite). In some embodiments, the synthetic fungicidal compound is potassium phosphite or ammonium phosphite.

In some embodiments, the synthetic fungicidal compound is selected from the group consisting of benalaxyl, benalaxyl-M (also known as kiralaxyl), furalaxyl, metalaxyl, oxadixyl, metalaxyl-M, famoxadone, azoxystrobin, pyraclostrobin, trifloxystrobin, fluoxastrobin, fenamidone, polyoxin, cymoxanil, potassium phosphite, ammonium phosphite, difenoconazole, dimethomorph, mandipropamid, cyanoacetamide-oxime, mancozeb, zoxamide, fluazinam, propamocarb, cyazofamid, chlorothalonil, copper, and triphenyltin hydroxide.

In some embodiments, the treatment is prophylactic treatment. In some embodiments, the treatment is curative.

There are also provided, in accordance with embodiments of the invention, (1) a method for reducing the dosage rate of a synthetic compound that has fungicidal activity against a plant-infection causing member of the class oomycetes, comprising applying to a plant having such an infection which has been treated with such a synthetic fungicidal compound a tea tree oil (TTO)-containing composition; and (2) a method for reducing the dosage rate of a TTO-containing composition, comprising applying to a plant having an infection caused by a member of the class oomycetes which has been treated with a TTO-containing composition a synthetic fungicidal compound.

In some embodiments, the infection is caused by a member selected from the group consisting of Phytophthora (e.g. Phytophthora infestans or Phytophthora capsici), Pseudoperonospora (e.g. Pseudoperonospora cubensis), Peronospora (e.g. Peronospora belbahrii), Plasmopara (e.g. Plasmopara viticola) and Pythium. In some embodiments, the infection is caused by an fungus oomycete selected from the group consisting of Pseudoperonospora cubensis (cucumber downy mildew) Plasmopara viticola (grapevine downy mildew), Bremia lactucae (lettuce downy mildew), Peronospora destructor (onion downy mildew), Peronospora viciae (pea downy mildew), Phytophthora infestans (potato blight), and Phytophthora capsici. In some embodiments, the infection is selected from the group consisting of cucumber downy mildew and grapevine downy mildew. In some embodiments, the composition is applied to the leaves of the plant.

In some embodiments, the TTO-containing composition comprises TTO and an emulsifier. In some embodiments the emulsifier is an alkali metal salt of a C₆-C₂₆ fatty acid, an ammonium salt of a C₆-C₂₆ fatty acid, or a mixture of such salts. In some embodiments the emulsifier is selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates. In some embodiments, the TTO-containing composition is an oil-in-water emulsion. In some embodiments, the TTO is present in the TTO-containing composition in an amount of from 0.01 wt. % to 10 wt. %. In some embodiments, the TTO is present in the TTO-containing composition in an amount of not more than 9 wt. %. In some embodiments, the TTO is present in the TTO-containing composition in an amount of not more than 8 wt. %. In some embodiments, the TTO is present in the TTO-containing composition in an amount of not more than 7 wt. %. In some embodiments, the TTO is present in the TTO-containing composition in an amount of not more than 6 wt. %. In some embodiments, the TTO is present in the TTO-containing composition in an amount of not more than 5 wt. %. In some embodiments, the TTO is present in the TTO-containing composition in an amount of not more than 4 wt. %. In some embodiments, the TTO is present in the TTO-containing composition in an amount of not more than 3 wt. %. In some embodiments, the TTO is present in the TTO-containing composition in an amount of not more than 2 wt. %. In some embodiments, the TTO is present in the TTO-containing composition in an amount of not more than 1 wt. %. In some embodiments, the TTO is present in the TTO-containing composition in an amount of at least 0.02 wt. %. In some embodiments, the TTO is present in the TTO-containing composition in an amount of at least 0.03 wt. %. In some embodiments, the TTO is present in the TTO-containing composition in an amount of at least 0.04 wt. %. In some embodiments, the TTO is present in the TTO-containing composition in an amount of at least 0.05 wt. %. In some embodiments, the TTO is present in the TTO-containing composition in an amount of at least 0.06 wt. %. In some embodiments, the TTO is present in the TTO-containing composition in an amount of at least 0.07 wt. %. In some embodiments, the TTO is present in the TTO-containing composition in an amount of at least 0.08 wt. %. In some embodiments, the TTO is present in the TTO-containing composition in an amount of at least 0.09 wt. %. In some embodiments, the TTO is present in the TTO-containing composition in an amount of at least 0.1 wt. %. In some embodiments, the TTO is present in the TTO-containing composition in an amount of at least 0.2 wt. %. In some embodiments, the TTO is present in the TTO-containing composition in an amount of at least 0.3 wt. %. In some embodiments, the TTO is present in the TTO-containing composition in an amount of at least 0.4 wt. %. In some embodiments, the TTO is present in the TTO-containing composition in an amount of at least 0.5 wt. %. In some embodiments, the TTO is present in the TTO-containing composition in an amount of at least 0.6 wt. %. In some embodiments, the TTO is present in the TTO-containing composition in an amount of at least 0.7 wt. %. In some embodiments, the TTO is present in the TTO-containing composition in an amount of at least 0.8 wt. %. In some embodiments, the TTO is present in the TTO-containing composition in an amount of at least 0.9 wt. %. In some embodiments, the TTO is present in the TTO-containing composition in an amount of at least 1.0 wt. %.

In some embodiments, the TTO-containing composition further comprises an additional etheric oil. In some embodiments, the additional etheric oil is selected from the group consisting of lavender (Lavandula angustifolia) oil, pine (Pinus sylvestris) oil, manuka (Leptosperemum scoparium) oil, kanuca (Kunzea ericoids) oil, eucalyptus (Eucaluptus globules) oil, bergamot (Citrus bergamia) oil, clove (Eugenia caryaphylata) oil, lemon (Citrus limoneum) oil, lemon grass (Cymbpogon citrates) oil, rosemary (Rosmarinus officialis) oil, geranium (Pelargonium graveoleus) oil, and mint oil, the latter of which refers to an etheric oil containing high levels of menthol and/or methane; and mixtures thereof.

In some embodiments, the TTO-containing composition further comprises the synthetic fungicidal compound. In some embodiments, the combination of TTO and synthetic fungicidal compound is applied simultaneously. In some embodiments, the combination of TTO and synthetic fungicidal compound is applied as a single mixture. In some embodiments, the combination of TTO and synthetic fungicidal compound is applied sequentially. In some embodiments, the combination of TTO and synthetic fungicidal compound is applied as separate compositions. In some embodiments, the combination of TTO and synthetic fungicidal compound is applied in conjunction with at least one of a mineral oil and an emulsifier.

In some embodiments, the synthetic fungicidal compound is applied at a dosage rate that is less than the rate indicated by the manufacturer as being the correct dosage rate in the absence of TTO. In some embodiments, the dosage rate at which the synthetic fungicidal compound is applied is not greater than 95% of the correct dosage rate as indicated by the manufacturer in the absence of TTO. In some embodiments, the dosage rate at which the synthetic fungicidal compound is applied is not greater than 90% of the correct dosage rate as indicated by the manufacturer in the absence of TTO. In some embodiments, the dosage rate at which the synthetic fungicidal compound is applied is not greater than 85% of the correct dosage rate as indicated by the manufacturer in the absence of TTO. In some embodiments, the dosage rate at which the synthetic fungicidal compound is applied is not greater than 80% of the correct dosage rate as indicated by the manufacturer in the absence of TTO. In some embodiments, the dosage rate at which the synthetic fungicidal compound is applied is not greater than 75% of the correct dosage rate as indicated by the manufacturer in the absence of TTO. In some embodiments, the dosage rate at which the synthetic fungicidal compound is applied is not greater than 70% of the correct dosage rate as indicated by the manufacturer in the absence of TTO. In some embodiments, the dosage rate at which the synthetic fungicidal compound is applied is not greater than 65% of the correct dosage rate as indicated by the manufacturer in the absence of TTO. In some embodiments, the dosage rate at which the synthetic fungicidal compound is applied is not greater than 60% of the correct dosage rate as indicated by the manufacturer in the absence of TTO. In some embodiments, the dosage rate at which the synthetic fungicidal compound is applied is not greater than 55% of the correct dosage rate as indicated by the manufacturer in the absence of TTO. In some embodiments, the dosage rate at which the synthetic fungicidal compound is applied is not greater than 50% of the correct dosage rate as indicated by the manufacturer in the absence of TTO. In some embodiments, the dosage rate at which the synthetic fungicidal compound is applied is not greater than 45% of the correct dosage rate as indicated by the manufacturer in the absence of TTO. In some embodiments, the dosage rate at which the synthetic fungicidal compound is applied is not greater than 40% of the correct dosage rate as indicated by the manufacturer in the absence of TTO. In some embodiments, the dosage rate at which the synthetic fungicidal compound is applied is not greater than 35% of the correct dosage rate as indicated by the manufacturer in the absence of TTO. In some embodiments, the dosage rate at which the synthetic fungicidal compound is applied is not greater than 30% of the correct dosage rate as indicated by the manufacturer in the absence of TTO. In some embodiments, the dosage rate at which the synthetic fungicidal compound is applied is at least 40% of the correct dosage rate as indicated by the manufacturer in the absence of TTO. In some embodiments, the dosage rate at which the synthetic fungicidal compound is applied is at least 45% of the correct dosage rate as indicated by the manufacturer in the absence of TTO. In some embodiments, the dosage rate at which the synthetic fungicidal compound is applied is at least 50% of the correct dosage rate as indicated by the manufacturer in the absence of TTO. In some embodiments, the dosage rate at which the synthetic fungicidal compound is applied is at least 55% of the correct dosage rate as indicated by the manufacturer in the absence of TTO. In some embodiments, the dosage rate at which the synthetic fungicidal compound is applied is at least 60% of the correct dosage rate as indicated by the manufacturer in the absence of TTO. In some embodiments, the dosage rate at which the synthetic fungicidal compound is applied is at least 65% of the correct dosage rate as indicated by the manufacturer in the absence of TTO. In some embodiments, the dosage rate at which the synthetic fungicidal compound is applied is at least 70% of the correct dosage rate as indicated by the manufacturer in the absence of TTO. In some embodiments, the dosage rate at which the synthetic fungicidal compound is applied is at least 75% of the correct dosage rate as indicated by the manufacturer in the absence of TTO.

In some embodiments, the TTO-containing composition is applied at a dosage rate that is less than the rate indicated by the manufacturer as the rate used when the TTO-containing composition is applied in the absence of a synthetic fungicidal compound. In some embodiments, the dosage rate at which the TTO-containing composition is applied is not greater than 95% of the correct dosage rate as indicated by the manufacturer in the absence of application of a synthetic fungicidal compound. In some embodiments, the dosage rate at which the TTO-containing composition is applied is not greater than 90% of the correct dosage rate as indicated by the manufacturer in the absence of application of a synthetic fungicidal compound. In some embodiments, the dosage rate at which the TTO-containing composition is applied is not greater than 85% of the correct dosage rate as indicated by the manufacturer in the absence of application of a synthetic fungicidal compound. In some embodiments, the dosage rate at which the TTO-containing composition is applied is not greater than 80% of the correct dosage rate as indicated by the manufacturer in the absence of application of a synthetic fungicidal compound. In some embodiments, the dosage rate at which the TTO-containing composition is applied is not greater than 75% of the correct dosage rate as indicated by the manufacturer in the absence of application of a synthetic fungicidal compound. In some embodiments, the dosage rate at which the TTO-containing composition is applied is not greater than 70% of the correct dosage rate as indicated by the manufacturer in the absence of application of a synthetic fungicidal compound. In some embodiments, the dosage rate at which the TTO-containing composition is applied is not greater than 65% of the correct dosage rate as indicated by the manufacturer in the absence of application of a synthetic fungicidal compound. In some embodiments, the dosage rate at which the TTO-containing composition is applied is not greater than 60% of the correct dosage rate as indicated by the manufacturer in the absence of application of a synthetic fungicidal compound. In some embodiments, the dosage rate at which the TTO-containing composition is applied is not greater than 55% of the correct dosage rate as indicated by the manufacturer in the absence of application of a synthetic fungicidal compound. In some embodiments, the dosage rate at which the TTO-containing composition is applied is not greater than 50% of the correct dosage rate as indicated by the manufacturer in the absence of application of a synthetic fungicidal compound. In some embodiments, the dosage rate at which the TTO-containing composition is applied is not greater than 45% of the correct dosage rate as indicated by the manufacturer in the absence of application of a synthetic fungicidal compound. In some embodiments, the dosage rate at which the TTO-containing composition is applied is not greater than 40% of the correct dosage rate as indicated by the manufacturer in the absence of application of a synthetic fungicidal compound. In some embodiments, the TTO-containing composition is applied is not greater than 35% of the correct dosage rate as indicated by the manufacturer in the absence of application of a synthetic fungicidal compound. In some embodiments, the dosage rate at which the TTO-containing composition is applied is not greater than 30% of the correct dosage rate as indicated by the manufacturer in the absence of application of a synthetic fungicidal compound. In some embodiments, the dosage rate at which the TTO-containing composition is applied is at least 40% of the correct dosage rate as indicated by the manufacturer in the absence of application of a synthetic fungicidal compound. In some embodiments, the dosage rate at which the TTO-containing composition is applied is at least 45% of the correct dosage rate as indicated by the manufacturer in the absence of application of a synthetic fungicidal compound. In some embodiments, the dosage rate at which the TTO-containing composition is applied is at least 50% of the correct dosage rate as indicated by the manufacturer in the absence of application of a synthetic fungicidal compound. In some embodiments, the dosage rate at which the TTO-containing composition is applied is at least 55% of the correct dosage rate as indicated by the manufacturer in the absence of application of a synthetic fungicidal compound. In some embodiments, the dosage rate at which the TTO-containing composition is applied is at least 60% of the correct dosage rate as indicated by the manufacturer in the absence of application of a synthetic fungicidal compound. In some embodiments, the dosage rate at which the TTO-containing composition is applied is at least 65% of the correct dosage rate as indicated by the manufacturer in the absence of application of a synthetic fungicidal compound. In some embodiments, the dosage rate at which the TTO-containing composition is applied is at least 70% of the correct dosage rate as indicated by the manufacturer in the absence of application of a synthetic fungicidal compound. In some embodiments, the dosage rate at which the TTO-containing composition is applied is at least 75% of the correct dosage rate as indicated by the manufacturer in the absence of application of a synthetic fungicidal compound.

In some embodiments, the synthetic fungicidal compound is selected from the group consisting of (a) PhenylAmides (PAs), such as benalaxyl, benalaxyl-M (also known as kiralaxyl), furalaxyl, metalaxyl, oxadixyl and metalaxyl-M (also known as mefenoxam); (b) Quinone outside Inhibitors (QoIs), such as famoxadone and strobilurins such as azoxystrobin, pyraclostrobin, trifloxystrobin, fluoxastrobin, and fenamidone; (c) Polyoxins, (d) Cyanoacetamide oximes, such as cymoxanil, (e) Phosphonates (also sometimes referred to as phosphites), e.g. potassium phosphite (KHP(O₂)OH), (f) demethylation inhibitors (DMIs), such as difenoconazole, (g) Carboxylic Acid Amides (CAAs), such as dimethomorph and mandipropamid, (h) Cyanoacetamide-oxime; (i) Dithiocarbamates such as mancozeb; (j) Benzamides such as zoxamide, (k) 2,6-Dinitroanilines such as fluazinam, (l) Carbamates such as propamocarb, (m) Quinone inside Inhibitors (QiIs) such as cyazofamid, (n) Chloronitriles such as chlorothalonil, (o) copper-based products, and (p) organotin compounds such as triphenyltin hydroxide.

In some embodiments, the synthetic fungicidal compound is a compound that is indicated for the treatment of cucumber downy mildew, and the combination is applied to at least one cucumber plant. In some embodiments, the synthetic fungicidal compound is selected from the group consisting of phosphorous acid and salts thereof (e.g. potassium phosphite), copper, mefenoxam, chlorothanonil, polymeric manganese ethylene bis(dithiocarbamate), mancozeb, cymoxanil, dimethomorph, zoxamide, propamocarb, cyazofamid, cymoxanil, and famoxadone. In some embodiments, the synthetic fungicidal compound is potassium phosphite or ammonium phosphite.

In some embodiments, the synthetic fungicidal compound is a compound that is indicated for the treatment of grapevine downy mildew, and the combination is applied to at least one grape plant. In some embodiments, the synthetic fungicidal compound is selected from the group consisting of azoxystrobin, mancozeb, captan, copper-containing fungicides, metalaxyl and phosphorous acid and salts thereof (e.g. potassium phosphite). In some embodiments, the synthetic fungicidal compound is potassium phosphite or ammonium phosphite.

In some embodiments, the synthetic fungicidal compound is selected from the group consisting of benalaxyl, benalaxyl-M (also known as kiralaxyl), furalaxyl, metalaxyl, oxadixyl, metalaxyl-M, famoxadone, azoxystrobin, pyraclostrobin, trifloxystrobin, fluoxastrobin, fenamidone, polyoxin, cymoxanil, potassium phosphite, ammonium phosphite, difenoconazole, dimethomorph, mandipropamid, cyanoacetamide-oxime, mancozeb, zoxamide, fluazinam, propamocarb, cyazofamid, chlorothalonil, copper, and triphenyltin hydroxide.

In some embodiments, the treatment is prophylactic treatment. In some embodiments, the treatment is curative.

There is also provided, in accordance with an embodiment of the invention, a kit containing at least one of tea tree oil (TTO) and a synthetic fungicidal compound which is active against a fungus of the class oomycetes, and instructions that instruct the user how to treat a plant infection caused by a fungus of the class oomycetes by applying to the plant a combination of a TTO composition and a synthetic fungicidal compound. In some embodiments, the kit contains TTO in a TTO-containing composition. In some embodiments, the kit contains a synthetic fungicidal compound which is active against a fungus of the class oomycetes. In some embodiments, the instructions instruct to apply the synthetic fungicidal compound at a dosage rate that is less than the rate indicated by the manufacturer as being the correct dosage rate in the absence of a TTO-containing composition. In some embodiments, the instructions instruct to apply the TTO at a dosage rate that is less than the rate indicated by the manufacturer of the TTO as being the correct dosage rate in the absence of a synthetic fungicidal composition. In some embodiments, the instructions instruct to apply the combination simultaneously. In some embodiments, the instructions instruct to apply the combination as a single mixture. In some embodiments, the instructions instruct to apply the combination sequentially. In some embodiments, the instructions instruct to apply the combination as separate compositions. In some embodiments, the instructions instruct to apply the combination in conjunction with at least one of a mineral oil and an emulsifier.

In some embodiments, the instructions instruct to apply the synthetic fungicidal compound at a dosage rate which is not greater than 95% of the correct dosage rate as indicated by the manufacturer in the absence of TTO. In some embodiments, the instructions instruct to apply the synthetic fungicidal compound at a dosage rate at which not greater than 90% of the correct dosage rate as indicated by the manufacturer in the absence of TTO. In some embodiments, the instructions instruct to apply the synthetic fungicidal compound at a dosage rate at which not greater than 85% of the correct dosage rate as indicated by the manufacturer in the absence of TTO. In some embodiments, the instructions instruct to apply the synthetic fungicidal compound at a dosage rate at which not greater than 80% of the correct dosage rate as indicated by the manufacturer in the absence of TTO. In some embodiments, the instructions instruct to apply the synthetic fungicidal compound at a dosage rate at which not greater than 75% of the correct dosage rate as indicated by the manufacturer in the absence of TTO. In some embodiments, the instructions instruct to apply the synthetic fungicidal compound at a dosage rate at which not greater than 70% of the correct dosage rate as indicated by the manufacturer in the absence of TTO. In some embodiments, the instructions instruct to apply the synthetic fungicidal compound at a dosage rate at which not greater than 65% of the correct dosage rate as indicated by the manufacturer in the absence of TTO. In some embodiments, the instructions instruct to apply the synthetic fungicidal compound at a dosage rate at which not greater than 60% of the correct dosage rate as indicated by the manufacturer in the absence of TTO. In some embodiments, the instructions instruct to apply the synthetic fungicidal compound at a dosage rate at which not greater than 55% of the correct dosage rate as indicated by the manufacturer in the absence of TTO. In some embodiments, the instructions instruct to apply the synthetic fungicidal compound at a dosage rate at which not greater than 50% of the correct dosage rate as indicated by the manufacturer in the absence of TTO. In some embodiments, the instructions instruct to apply the synthetic fungicidal compound at a dosage rate at which not greater than 45% of the correct dosage rate as indicated by the manufacturer in the absence of TTO. In some embodiments, the instructions instruct to apply the synthetic fungicidal compound at a dosage rate at which not greater than 40% of the correct dosage rate as indicated by the manufacturer in the absence of TTO. In some embodiments, the instructions instruct to apply the synthetic fungicidal compound at a dosage rate at which not greater than 35% of the correct dosage rate as indicated by the manufacturer in the absence of TTO. In some embodiments, the instructions instruct to apply the synthetic fungicidal compound at a dosage rate at which not greater than 30% of the correct dosage rate as indicated by the manufacturer in the absence of TTO. In some embodiments, the instructions instruct to apply the synthetic fungicidal compound at a dosage rate that is at least 40% of the correct dosage rate as indicated by the manufacturer in the absence of TTO. In some embodiments, the instructions instruct to apply the synthetic fungicidal compound at a dosage rate that is at least 45% of the correct dosage rate as indicated by the manufacturer in the absence of TTO. In some embodiments, the instructions instruct to apply the synthetic fungicidal compound at a dosage rate that is at least 50% of the correct dosage rate as indicated by the manufacturer in the absence of TTO. In some embodiments, the instructions instruct to apply the synthetic fungicidal compound at a dosage rate that is at least 55% of the correct dosage rate as indicated by the manufacturer in the absence of TTO. In some embodiments, the instructions instruct to apply the synthetic fungicidal compound at a dosage rate that is at least 60% of the correct dosage rate as indicated by the manufacturer in the absence of TTO. In some embodiments, the instructions instruct to apply the synthetic fungicidal compound at a dosage rate that is at least 65% of the correct dosage rate as indicated by the manufacturer in the absence of TTO. In some embodiments, the instructions instruct to apply the synthetic fungicidal compound at a dosage rate that is at least 70% of the correct dosage rate as indicated by the manufacturer in the absence of TTO. In some embodiments, the instructions instruct to apply the synthetic fungicidal compound at a dosage rate that is at least 75% of the correct dosage rate as indicated by the manufacturer in the absence of TTO.

In some embodiments, the instructions instruct to apply the TTO-containing composition at a dosage rate that is less than the rate indicated by the manufacturer as the rate used when the TTO-containing composition is applied in the absence of a synthetic fungicidal compound. In some embodiments, the instructions instruct to apply the TTO-containing composition at a dosage rate that is not greater than 95% of the correct dosage rate as indicated by the manufacturer in the absence of application of a synthetic fungicidal compound. In some embodiments, the instructions instruct to apply the TTO-containing composition at a dosage rate that is not greater than 90% of the correct dosage rate as indicated by the manufacturer in the absence of application of a synthetic fungicidal compound. In some embodiments, the instructions instruct to apply the TTO-containing composition at a dosage rate that is not greater than 85% of the correct dosage rate as indicated by the manufacturer in the absence of application of a synthetic fungicidal compound. In some embodiments, the instructions instruct to apply the TTO-containing composition at a dosage rate that is not greater than 80% of the correct dosage rate as indicated by the manufacturer in the absence of application of a synthetic fungicidal compound. In some embodiments, the instructions instruct to apply the TTO-containing composition at a dosage rate that is not greater than 75% of the correct dosage rate as indicated by the manufacturer in the absence of application of a synthetic fungicidal compound. In some embodiments, the instructions instruct to apply the TTO-containing composition at a dosage rate that is not greater than 70% of the correct dosage rate as indicated by the manufacturer in the absence of application of a synthetic fungicidal compound. In some embodiments, the instructions instruct to apply the TTO-containing composition at a dosage rate that is not greater than 65% of the correct dosage rate as indicated by the manufacturer in the absence of application of a synthetic fungicidal compound. In some embodiments, the instructions instruct to apply the TTO-containing composition at a dosage rate that is not greater than 60% of the correct dosage rate as indicated by the manufacturer in the absence of application of a synthetic fungicidal compound. In some embodiments, the instructions instruct to apply the TTO-containing composition at a dosage rate that is not greater than 55% of the correct dosage rate as indicated by the manufacturer in the absence of application of a synthetic fungicidal compound. In some embodiments, the instructions instruct to apply the TTO-containing composition at a dosage rate that is not greater than 50% of the correct dosage rate as indicated by the manufacturer in the absence of application of a synthetic fungicidal compound. In some embodiments, the instructions instruct to apply the TTO-containing composition at a dosage rate that is not greater than 45% of the correct dosage rate as indicated by the manufacturer in the absence of application of a synthetic fungicidal compound. In some embodiments, the instructions instruct to apply the TTO-containing composition at a dosage rate that is not greater than 40% of the correct dosage rate as indicated by the manufacturer in the absence of application of a synthetic fungicidal compound. In some embodiments, the instructions instruct to apply the TTO-containing composition at a dosage rate that is not greater than 35% of the correct dosage rate as indicated by the manufacturer in the absence of application of a synthetic fungicidal compound. In some embodiments, the instructions instruct to apply the TTO-containing composition at a dosage rate that is not greater than 30% of the correct dosage rate as indicated by the manufacturer in the absence of application of a synthetic fungicidal compound. In some embodiments, the instructions instruct to apply the TTO-containing composition at a dosage rate that at least 40% of the correct dosage rate as indicated by the manufacturer in the absence of application of a synthetic fungicidal compound. In some embodiments, the instructions instruct to apply the TTO-containing composition at a dosage rate that at least 45% of the correct dosage rate as indicated by the manufacturer in the absence of application of a synthetic fungicidal compound. In some embodiments, the instructions instruct to apply the TTO-containing composition at a dosage rate that at least 50% of the correct dosage rate as indicated by the manufacturer in the absence of application of a synthetic fungicidal compound. In some embodiments, the instructions instruct to apply the TTO-containing composition at a dosage rate that at least 55% of the correct dosage rate as indicated by the manufacturer in the absence of application of a synthetic fungicidal compound. In some embodiments, the instructions instruct to apply the TTO-containing composition at a dosage rate that at least 60% of the correct dosage rate as indicated by the manufacturer in the absence of application of a synthetic fungicidal compound. In some embodiments, the instructions instruct to apply the TTO-containing composition at a dosage rate that at least 65% of the correct dosage rate as indicated by the manufacturer in the absence of application of a synthetic fungicidal compound. In some embodiments, the instructions instruct to apply the TTO-containing composition at a dosage rate that at least 70% of the correct dosage rate as indicated by the manufacturer in the absence of application of a synthetic fungicidal compound. In some embodiments, the instructions instruct to apply the TTO-containing composition at a dosage rate that at least 75% of the correct dosage rate as indicated by the manufacturer in the absence of application of a synthetic fungicidal compound.

In some embodiments, the synthetic fungicidal compound is selected from the group consisting of (a) PhenylAmides (PAs), such as benalaxyl, benalaxyl-M (also known as kiralaxyl), furalaxyl, metalaxyl, oxadixyl and metalaxyl-M (also known as mefenoxam); (b) Quinone outside Inhibitors (QoIs), such as famoxadone and strobilurins such as azoxystrobin, pyraclostrobin, trifloxystrobin, fluoxastrobin, and fenamidone; (c) Polyoxins, (d) Cyanoacetamide oximes, such as cymoxanil, (e) Phosphonates (also sometimes referred to as phosphites), e.g. potassium phosphite (KHP(O₂)OH), (f) demethylation inhibitors (DMIs), such as difenoconazole, (g) Carboxylic Acid Amides (CAAs), such as dimethomorph and mandipropamid, (h) Cyanoacetamide-oxime; (i) Dithiocarbamates such as mancozeb; (j) Benzamides such as zoxamide, (k) 2,6-Dinitroanilines such as fluazinam, (l) Carbamates such as propamocarb, (m) Quinone inside Inhibitors (QiIs) such as cyazofamid, (n) Chloronitriles such as chlorothalonil, (o) copper-based products, and (p) organotin compounds such as triphenyltin hydroxide.

In some embodiments, the synthetic fungicidal compound is a compound that is indicated for the treatment of cucumber downy mildew, and the combination is applied to at least one cucumber plant. In some embodiments, the synthetic fungicidal compound is selected from the group consisting of phosphorous acid and salts thereof (e.g. potassium phosphite), copper, mefenoxam, chlorothanonil, polymeric manganese ethylene bis(dithiocarbamate), mancozeb, cymoxanil, dimethomorph, zoxamide, propamocarb, cyazofamid, cymoxanil, and famoxadone. In some embodiments, the synthetic fungicidal compound is potassium phosphite or ammonium phosphite.

In some embodiments, the synthetic fungicidal compound is a compound that is indicated for the treatment of grapevine downy mildew, and the combination is applied to at least one grape plant. In some embodiments, the synthetic fungicidal compound is selected from the group consisting of azoxystrobin, mancozeb, captan, copper-containing fungicides, metalaxyl and phosphorous acid and salts thereof (e.g. potassium phosphite). In some embodiments, the synthetic fungicidal compound is potassium phosphite or ammonium phosphite.

In some embodiments, the synthetic fungicidal compound is selected from the group consisting of benalaxyl, benalaxyl-M (also known as kiralaxyl), furalaxyl, metalaxyl, oxadixyl, metalaxyl-M, famoxadone, azoxystrobin, pyraclostrobin, trifloxystrobin, fluoxastrobin, fenamidone, polyoxin, cymoxanil, potassium phosphite, ammonium phosphite, difenoconazole, dimethomorph, mandipropamid, cyanoacetamide-oxime, mancozeb, zoxamide, fluazinam, propamocarb, cyazofamid, chlorothalonil, copper, and triphenyltin hydroxide.

In some embodiments, the treatment is prophylactic treatment. In some embodiments, the treatment is curative.

There is also provided, in accordance with an embodiment of the invention, a composition comprising tea tree oil (TTO) and at least one synthetic fungicidal compound that is active against a member of the class oomycetes. In some embodiments, the at least on synthetic fungicidal compound is not indicated for treatment of an infection of a fungus of the class ascomycetes. In some embodiments, the at least on synthetic fungicidal compound is not known to be active against a fungus of the class ascomycetes. In some embodiments, the composition contains both the TTO and the at least one synthetic fungicidal compound at concentrations that allow the composition to be applied to a plant infected with an infection caused by a fungus of the class oomycetes to treat the infection without at least one of (a) inducing phytoxicity in the plant and (b) violating government regulations. In some embodiments, the composition contains both the TTO and the at least one synthetic fungicidal compound at concentrations that require the composition to be diluted prior to application to a plant infected with an infection caused by a fungus of the class oomycetes in order to treat the infection without at least one of (a) inducing phytoxicity in the plant and (b) violating government regulations. In some embodiments, the composition further comprises at least one of a mineral oil and an emulsifier. In some embodiments the emulsifier is an alkali metal salt of a C₆-C₂₆ fatty acid, and ammonium salt of a C₆-C₂₆ fatty acid, or a mixture of such salts. In some embodiments, the emulsifier is selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates.

In some embodiments, the concentration of the synthetic fungicidal compound is not greater than 95% of the concentration of the synthetic fungicidal compound in fungicidal compositions prepared in accordance with the manufacturer's instructions in the absence of TTO. In some embodiments, the concentration of the synthetic fungicidal compound is not greater than 90% of the concentration of the synthetic fungicidal compound in fungicidal compositions prepared in accordance with the manufacturer's instructions in the absence of TTO. In some embodiments, the concentration of the synthetic fungicidal compound is not greater than 85% of the concentration of the synthetic fungicidal compound in fungicidal compositions prepared in accordance with the manufacturer's instructions in the absence of TTO. In some embodiments, the concentration of the synthetic fungicidal compound is not greater than 80% of the concentration of the synthetic fungicidal compound in fungicidal compositions prepared in accordance with the manufacturer's instructions in the absence of TTO. In some embodiments, the concentration of the synthetic fungicidal compound is not greater than 75% of the concentration of the synthetic fungicidal compound in fungicidal compositions prepared in accordance with the manufacturer's instructions in the absence of TTO. In some embodiments, the concentration of the synthetic fungicidal compound is not greater than 70% of the concentration of the synthetic fungicidal compound in fungicidal compositions prepared in accordance with the manufacturer's instructions in the absence of TTO. In some embodiments, the concentration of the synthetic fungicidal compound is not greater than 65% of the concentration of the synthetic fungicidal compound in fungicidal compositions prepared in accordance with the manufacturer's instructions in the absence of TTO. In some embodiments, the concentration of the synthetic fungicidal compound is not greater than 60% of the concentration of the synthetic fungicidal compound in fungicidal compositions prepared in accordance with the manufacturer's instructions in the absence of TTO. In some embodiments, the concentration of the synthetic fungicidal compound is not greater than 55% of the concentration of the synthetic fungicidal compound in fungicidal compositions prepared in accordance with the manufacturer's instructions in the absence of TTO. In some embodiments, the concentration of the synthetic fungicidal compound is not greater than 50% of the concentration of the synthetic fungicidal compound in fungicidal compositions prepared in accordance with the manufacturer's instructions in the absence of TTO. In some embodiments, the concentration of the synthetic fungicidal compound is not greater than 45% of the concentration of the synthetic fungicidal compound in fungicidal compositions prepared in accordance with the manufacturer's instructions in the absence of TTO. In some embodiments, the concentration of the synthetic fungicidal compound is not greater than 40% of the concentration of the synthetic fungicidal compound in fungicidal compositions prepared in accordance with the manufacturer's instructions in the absence of TTO. In some embodiments, the concentration of the synthetic fungicidal compound is not greater than 35% of the concentration of the synthetic fungicidal compound in fungicidal compositions prepared in accordance with the manufacturer's instructions in the absence of TTO. In some embodiments, the concentration of the synthetic fungicidal compound is not greater than 30% of the concentration of the synthetic fungicidal compound in fungicidal compositions prepared in accordance with the manufacturer's instructions in the absence of TTO. In some embodiments, the concentration of the synthetic fungicidal compound is at least 40% of the concentration of the synthetic fungicidal compound in fungicidal compositions prepared in accordance with the manufacturer's instructions in the absence of TTO. In some embodiments, the concentration of the synthetic fungicidal compound is at least 45% of the concentration of the synthetic fungicidal compound in fungicidal compositions prepared in accordance with the manufacturer's instructions in the absence of TTO. In some embodiments, the concentration of the synthetic fungicidal compound is at least 50% of the concentration of the synthetic fungicidal compound in fungicidal compositions prepared in accordance with the manufacturer's instructions in the absence of TTO. In some embodiments, the concentration of the synthetic fungicidal compound is at least 55% of the concentration of the synthetic fungicidal compound in fungicidal compositions prepared in accordance with the manufacturer's instructions in the absence of TTO. In some embodiments, the concentration of the synthetic fungicidal compound is at least 60% of the concentration of the synthetic fungicidal compound in fungicidal compositions prepared in accordance with the manufacturer's instructions in the absence of TTO. In some embodiments, the concentration of the synthetic fungicidal compound is at least 65% of the concentration of the synthetic fungicidal compound in fungicidal compositions prepared in accordance with the manufacturer's instructions in the absence of TTO. In some embodiments, the concentration of the synthetic fungicidal compound is at least 70% of the concentration of the synthetic fungicidal compound in fungicidal compositions prepared in accordance with the manufacturer's instructions in the absence of TTO. In some embodiments, the concentration of the synthetic fungicidal compound is at least 75% of the concentration of the synthetic fungicidal compound in fungicidal compositions prepared in accordance with the manufacturer's instructions in the absence of TTO.

In some embodiments, the concentration of the TTO is less than the concentration of the TTO in fungicidal compositions prepared in accordance with the manufacturer's instructions in the absence of a synthetic fungicidal compound. In some embodiments, the concentration of the TTO is not greater than 95% of the concentration of the TTO in fungicidal compositions prepared in accordance with the manufacturer's instructions in the absence of a synthetic fungicidal compound. In some embodiments, the concentration of the TTO is not greater than 90% of the concentration of the TTO in fungicidal compositions prepared in accordance with the manufacturer's instructions in the absence of a synthetic fungicidal compound. In some embodiments, the concentration of the TTO is not greater than 85% of the concentration of the TTO in fungicidal compositions prepared in accordance with the manufacturer's instructions in the absence of a synthetic fungicidal compound. In some embodiments, the concentration of the TTO is not greater than 80% of the concentration of the TTO in fungicidal compositions prepared in accordance with the manufacturer's instructions in the absence of a synthetic fungicidal compound. In some embodiments, the concentration of the TTO is not greater than 75% of the concentration of the TTO in fungicidal compositions prepared in accordance with the manufacturer's instructions in the absence of a synthetic fungicidal compound. In some embodiments, the concentration of the TTO is not greater than 70% of the concentration of the TTO in fungicidal compositions prepared in accordance with the manufacturer's instructions in the absence of a synthetic fungicidal compound. In some embodiments, the concentration of the TTO is not greater than 65% of the concentration of the TTO in fungicidal compositions prepared in accordance with the manufacturer's instructions in the absence of a synthetic fungicidal compound. In some embodiments, the concentration of the TTO is not greater than 60% of the concentration of the TTO in fungicidal compositions prepared in accordance with the manufacturer's instructions in the absence of a synthetic fungicidal compound. In some embodiments, the concentration of the TTO is not greater than 55% of the concentration of the TTO in fungicidal compositions prepared in accordance with the manufacturer's instructions in the absence of a synthetic fungicidal compound. In some embodiments, the concentration of the TTO is not greater than 50% of the concentration of the TTO in fungicidal compositions prepared in accordance with the manufacturer's instructions in the absence of a synthetic fungicidal compound. In some embodiments, the concentration of the TTO is not greater than 45% of the concentration of the TTO in fungicidal compositions prepared in accordance with the manufacturer's instructions in the absence of a synthetic fungicidal compound. In some embodiments, the concentration of the TTO is not greater than 40% of the concentration of the TTO in fungicidal compositions prepared in accordance with the manufacturer's instructions in the absence of a synthetic fungicidal compound. In some embodiments, the concentration of the TTO is not greater than 35% of the concentration of the TTO in fungicidal compositions prepared in accordance with the manufacturer's instructions in the absence of a synthetic fungicidal compound. In some embodiments, the concentration of the TTO is not greater than 30% of the concentration of the TTO in fungicidal compositions prepared in accordance with the manufacturer's instructions in the absence of a synthetic fungicidal compound. In some embodiments, the concentration of the TTO is at least 40% of the concentration of the TTO in fungicidal compositions prepared in accordance with the manufacturer's instructions in the absence of a synthetic fungicidal composition. In some embodiments, the concentration of the TTO is at least 45% of the concentration of the TTO in fungicidal compositions prepared in accordance with the manufacturer's instructions in the absence of a synthetic fungicidal composition. In some embodiments, the concentration of the TTO is at least 50% of the concentration of the TTO in fungicidal compositions prepared in accordance with the manufacturer's instructions in the absence of a synthetic fungicidal composition. In some embodiments, the concentration of the TTO is at least 55% of the concentration of the TTO in fungicidal compositions prepared in accordance with the manufacturer's instructions in the absence of a synthetic fungicidal composition. In some embodiments, the concentration of the TTO is at least 60% of the concentration of the TTO in fungicidal compositions prepared in accordance with the manufacturer's instructions in the absence of a synthetic fungicidal composition. In some embodiments, the concentration of the TTO is at least 65% of the concentration of the TTO in fungicidal compositions prepared in accordance with the manufacturer's instructions in the absence of a synthetic fungicidal composition. In some embodiments, the concentration of the TTO is at least 70% of the concentration of the TTO in fungicidal compositions prepared in accordance with the manufacturer's instructions in the absence of a synthetic fungicidal composition. In some embodiments, the concentration of the TTO is at least 75% of the concentration of the TTO in fungicidal compositions prepared in accordance with the manufacturer's instructions in the absence of a synthetic fungicidal composition.

In some embodiments, the synthetic fungicidal compound is selected from the group consisting of (a) PhenylAmides (PAs), such as benalaxyl, benalaxyl-M (also known as kiralaxyl), furalaxyl, metalaxyl, oxadixyl and metalaxyl-M (also known as mefenoxam); (b) Quinone outside Inhibitors (QoIs), such as famoxadone and strobilurins such as azoxystrobin, pyraclostrobin, trifloxystrobin, fluoxastrobin, and fenamidone; (c) Polyoxins, (d) Cyanoacetamide oximes, such as cymoxanil, (e) Phosphonates (also sometimes referred to as phosphites), e.g. potassium phosphite (KHP(O₂)OH), (f) demethylation inhibitors (DMIs), such as difenoconazole, (g) Carboxylic Acid Amides (CAAs), such as dimethomorph and mandipropamid, (h) Cyanoacetamide-oxime; (i) Dithiocarbamates such as mancozeb; (j) Benzamides such as zoxamide, (k) 2,6-Dinitroanilines such as fluazinam, (l) Carbamates such as propamocarb, (m) Quinone inside Inhibitors (QiIs) such as cyazofamid, (n) Chloronitriles such as chlorothalonil, (o) copper-based products, and (p) organotin compounds such as triphenyltin hydroxide.

There is also provided, in accordance with an embodiment of the invention, a plant or a portion thereof which has been treated in accordance with a method in accordance with an embodiment of the invention. In some embodiments, the plant is selected from the group consisting of cucumber and grape.

There is also provided, in accordance with an embodiment of the invention, a fruit or vegetable having on its skin or its leaves a synthetic fungicidal compound and tea tree oil or residue of tea tree oil. In some embodiments, the synthetic fungicidal compound is active against a member of the class oomycetes but not against ascomycetes. In some embodiments, the fruit or vegetable is selected from the group consisting of cucumber and grape.

### DETAILED DESCRIPTION

There are provided in accordance with embodiments of the invention methods and compositions for treating infections in plants caused by members of the class oomycetes. Examples of such are Phytophthora (e.g. Phytophthora infestans or Phytophthora capsici), Pseudoperonospora (e.g. Pseudoperonospora cubensis), Peronospora (e.g. Peronospora belbahrii), Plasmopara (e.g. Plasmopara viticola) and Pythium. In some embodiments, the infection is caused by an oomycete selected from the group consisting of Pseudoperonospora cubensis (cucumber downy mildew) Plasmopara viticola (grapevine downy mildew), Bremia lactucae (lettuce downy mildew), Peronospora destructor (onion downy mildew), Peronospora viciae (pea downy mildew), Phytophthora infestans (potato blight), and Phytophthora capsici. Some examples of such infections are downy mildews in cucumber plants, grapevines, lettuce, onion plants and pea plants. In general these methods involve applying to the leaves of the plant a combination of tea tree oil (TTO) (which optionally may be in the form of a TTO-containing composition) and a synthetic fungicidal compound. While in some embodiments the invention may be practiced by using the synthetic fungicidal compound at its approved dosage level, in accordance with the manufacturer's instructions, in some embodiments the invention may be practiced by using the synthetic fungicidal compound at a dosage level below that indicated by the manufacturer and/or approved by the relevant regulatory authorities and/or indicated by FRAC for use of the compound without TTO.

The inventors have found that use of a combination of TTO and a synthetic fungicidal compound, wherein the latter is used at a dosage level below that indicated by the manufacturer without TTO and/or approved by the relevant regulatory authorities and/or indicated by FRAC for use of the compound without TTO, can be as effective in combating oomycetes infections, e.g. cucumber downy mildew and grapevine downy mildew, as using the synthetic fungicidal compound alone at the approved level or using TTO alone at the level indicated by the manufacturer. Such combined use, which may also elicit synergistic effects, facilitates a reduced chemical load on the plants, and increases their yield per hectare in comparison to currently indicated uses of commercially available synthetic fungicides used to combat oomycetes infections such as cucumber downy mildew. Furthermore, it has been found that, contrary to conventional wisdom (such as is reflected in the FRAC literature), such combined use does not result in an increased likelihood of the development of fungicidal resistance.

In this application, the term “synthetic fungicidal compound” or “synthetic antifungal compound” is used to refer to those antifungal compounds that are synthesized as opposed to occurring as such in nature. Similarly, “TTO” or “tea tree oil” refers to an essential oil, usually but not necessarily obtained from the leaves of Melaleuca alternifolia, Melaleuca dissitiflora or Melaleuca linariifolia and usually being clear and generally colorless to pale yellow in color, which meets ISO 4730 (2004) (“Oil of Melaleuca, Terpinen-4-ol type”, available from the ISO at http://www.iso.org/iso/iso catalogue/catalogue tc/catalogue detail.htm?csnumber=37033).

It will also be appreciated that synthetic fungicidal compounds are generally sold not as the pure chemical compound but as part of a composition that contains other ingredients, which is typically called a “formulation”. In some cases, the formulation as sold contains two active ingredients, each operating on the target fungus by a different mechanism of action. The formulation is sold with a label or other instructions for use, which in many countries must be approved by a governmental regulatory body. These instructions may instruct the end-user to dilute the formulation in a particular manner, or may instruct the end-user to use the formulation as sold. In either case, the instructions will indicate a minimum dosage to be used for each type of crop with which the formulation is to be used, for example X liters of the formulation (which the manufacturer has provided at a concentration of Q grams of active ingredient per liter and may have indicated should be diluted to W grams of active ingredient/liter before use) per Y hectares of crop, as well as how the formulation should be applied to the crop (e.g. by spraying). The manufacturer, or a trade group like FRAC, will often also indicate a maximum number of applications per growing season. These instructions are given not only to increase the likelihood of efficacy of the fungicide, but also to minimize the likelihood of the development of fungicidal resistance in the treated fungus or fungi. Thus, in the context of this application, when reference is made to “a dosage rate that is less than the rate indicated by the manufacturer as being the correct dosage rate in the absence of TTO” or “the concentration of the synthetic fungicidal compound in fungicidal compositions prepared in accordance with the manufacturer's instructions in the absence of TTO” or the like, it will be understood that this refers to such a minimum dosage, as would be understood by one skilled in the art even if the manufacturer of the particular fungicidal formulation in question did not indicate such a minimum dosage. The same is true regarding TTO and TTO-containing compositions, mutatis mutandis, when reference is made herein to a dosage rate, concentration or the like for TTO or for a TTO-containing a composition that is “indicated by the manufacturer as being the correct” dosage rate or concentration or the like “in the absence of a synthetic fungicidal composition”.

It will also be appreciated that as used herein, unless indicated otherwise “treatment” refers to both the prophylactic treatment of plants as well as the curative treatment thereof. It will be appreciated that prophylactic treatment includes both preventing ascomycetes infection as well as delaying the onset of such infection, and that curative treatment includes both suppressing or eradicating existing fungus as well as delaying or preventing the worsening of an existing infection.

As stated, the synthetic fungicidal compound will generally be supplied as a composition with other ingredients, i.e. as a formulation, although practice of embodiments of the invention is not limited to such cases, and, as is known in the art, it is possible to formulate the raw chemical into a composition which can then be further mixed or diluted for use in accordance with embodiments of the invention. For example, if the raw synthetic fungicidal compound is not water soluble or is only sparingly soluble in water, emulsifiable concentrates or emulsions may be prepared by dissolving the synthetic fungicidal compound in an organic solvent optionally containing a wetting or emulsifying agent and then adding the mixture to water which may also contain a wetting or emulsifying agent. Suitable organic solvents include aromatic solvents such as alkylbenzenes and alkylnaphthalenes, ketones such as cyclohexanone and methylcyclohexanone, chlorinated hydrocarbons such as chlorobenzene and trichlorethane, and alcohols such as benzyl alcohol, furfuryl alcohol, butanol and glycol ethers. Suspension concentrates of largely insoluble solids may be prepared by ball or bead milling with a dispersing agent with a suspending agent included to stop the solid settling. By including suitable additives, for example additives for improving the distribution, adhesive power and resistance to rain on treated surfaces, the different compositions can be better adapted for various utilities. Emulsifiable concentrates and suspension concentrates will normally contain surfactants, e.g. a wetting agent, dispersing agent, emulsifying agent or suspending agent. These agents can be cationic, anionic or non-ionic agents. Suitable cationic agents are, for example, quaternary ammonium compounds, for example, cetyltrimethylammonium bromide. Suitable anionic agents are soaps, salts of aliphatic monoesters of sulphuric acid (for example, sodium lauryl sulphate), and salts of sulphonated aromatic compounds (for example, sodium dodecylbenzenesulphonate, sodium, calcium or ammonium lignosulphonate, butylnaphthalene sulphonate, and a mixture of sodium diisopropyl- and triisopropylnaphthalene sulphonates). Suitable non-ionic agents are, for example, the condensation products of ethylene oxide with fatty alcohols such as oleyl or cetyl alcohol, or with alkyl phenols such as octyl- or nonylphenol and octylcresol. Other non-ionic agents are the partial esters derived from long chain fatty acids and hexitol anhydrides, the condensation products of the said partial esters with ethylene oxide, and the lecithins. Suitable suspending agents are hydrophilic colloids (for example, polyvinylpyrrolidone and sodium carboxymethylcellulose), and swelling clays such as bentonite or attapulgite. Compositions for use as aqueous dispersions or emulsions are generally supplied in the form of a concentrate containing a high proportion of the active ingredient, the concentrate being diluted with water before use. These concentrates should preferably be able to withstand storage for prolonged periods and after such storage be capable of dilution with water in order to form aqueous preparations which remain homogeneous for a sufficient time to enable them to be applied by conventional spray equipment. The concentrates may conveniently contain up to 95%, suitably 10-85%, for example 25-60%, by weight of the active ingredient. After dilution to form aqueous preparations, such preparations may contain varying amounts of the active ingredient depending upon the intended purpose, but an aqueous preparation containing 0.0005% to 10%, more often 0.01% to 10%, by weight of active ingredient may be used.

Similarly, the TTO will generally be supplied in the form of a composition, e.g. an oil-in-water emulsion, such as is described in US Patent Publication No. 2007/0237837 or as available commercially as Timorex Gold®. However, it will be appreciated that, as described e.g. in US Patent Publication No. 2007/0237837, it is possible to formulate TTO into a composition which can then be further mixed or diluted for use in accordance with embodiments of the invention.

Thus, for example, an aqueous solution of an ammonium or alkali metal salt of a C₆₋₂₆ fatty acid (or mixture of such fatty acids) may be prepared by mixing such a fatty acid with an aqueous solution of a base (or a mixture of bases) such as NaOH, KOH, Na₂CO₃, KHCO₃, and NH₃; TTO may then be mixed into this solution. Depending on the proportions of water, TTO, and fatty acid salt, the result will be either a water-in-oil emulsion (if the TTO is the predominant ingredient) or an oil-in-water emulsion (if the water is the predominant ingredient). Alternatively, TTO and a C₆-C₂₆ fatty acid or mixture of such fatty acids may be mixed together, and an aqueous solution of a base (or a mixture of bases) such as NaOH, KOH, Na₂CO₃, KHCO₃, and NH₃ may be mixed into this mixture. If desired, this mixture may be further diluted by further addition of water. Depending on the proportions of water, TTO, and fatty acid and base, the result will be either a water-in-oil emulsion (if the TTO is the predominant ingredient) or an oil-in-water emulsion (if the water is the predominant ingredient). Other organic ingredients, such as other emulsifiers, co-solvents such as C₁₋₈ alcohols (such as methanol, ethanol, propanol, butanol and the like) or petroleum distillates having a suitable carbon chain range and distribution, and additional etheric oils, may be added at any stage of the mixing process. This composition will generally be further diluted in water prior to use, so that the concentration of TTO in the composition that is actually applied to a plant will generally range from about 0.01 wt. % to about 5 wt. %, although in principle the weight percentage of TTO may be somewhat higher, provided it is not so high that it exerts a phytotoxic effect on the plant being treated. Also, in principle it is possible to use other liquids to dilute the composition, e.g. methanol or ethanol, although water is most commonly used; as mentioned, alcohols, e.g. C₁₋₈ alcohols such as ethanol, methanol, isopropanol, butanol, and the like, in small amounts, may be also be useful for formulating the material.

The fatty acids themselves, which may be utilized in a suitable weight ratio relative to the TTO, as is known in the art (see e.g. US 2007/0237837 or WO 2004/021792), may be saturated or unsaturated and straight- or branched-chain. Examples of such are myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid; caproic acid (hexanoic acid), enanthic acid (heptanoic acid), caprylic acid (octanoic acid), pelargonic acid (nonanoic acid), capric acid (decanoic acid), undecylic acid (undecanoic acid), lauric acid (dodecanoic acid), tridecylic acid (tridecanoic acid), myristic acid (tetradecanoic acid), pentadecylic acid (pentadecanoic acid), palmitic acid (hexadecanoic acid), margaric acid (heptadecanoic acid), stearic acid (octadecanoic acid), nonadecylic acid (nonadecanoic acid), arachidic acid (eicosanoic acid), heneicosylic acid (heneicosanoic acid), behenic acid (docosanoic acid), tricosylic acid (tricosanoic acid), lignoceric acid (tetracosanoic acid), pentacosylic acid (pentacosanoic acid) and cerotic acid (hexacosanoic acid). Other emulsifiers which may additionally or alternatively be incorporated into the compositions prior to further dilution with water include, for example, ethoxylated fatty acids, ethoxylated castor oils, sorbitans ester, dodecylbenzene sulphonates, and ethoxylated tristyrylphenol phosphates; as will be appreciated by those skilled in the art, these emulsifiers are generally synthetic emulsifiers. Other examples of suitable emulsifiers (some of which, as will be appreciated by persons skilled in the art, are also surfactants) are alkali metal salts of, alkaline earth metal of, and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors, methylcellulose, nonyl phenol ethoxylates (such as nonylphenol polyglycol ether with 4 to 30 EO), octyl phenol ethoxylates (such as isooctylphenol polyglycol ether with EO), tributyl phenol ethoxylates (such as tri-sec-butylphenol polyglycol ether with 4 to 50 EO), tristyrylphenol phosphate (TSP) ethoxylates (such as 2,4,6-tri-(1-phenylethyl)-phenol polyglycol ether with 20 EO), castor oil ethoxylates (such as castor oil ethoxylate with 6 to 54 EO), alkoxylates (such as fatty alcohol block polyalkoxylate with EO), fatty alcohol ethoxylates (such as unsaturated fatty alcohol polyglycol ether with 20 to 80 EO), oxo alcohol polyglycol ether with 4 to 11 EO, alkylbenzene sulfonates (such as alkyl benzene sulfonate triethanolamine salt, alkyl benzene sulfonate sodium salt, alkyl benzene sulfonate calcium salt), fatty acid ethoxylate with 6 to 40 EO, and dodecylbenzene sulphonates (such as calcium dodecyl benzen sulfonate); as is known in the art, “EO” refers to the degree of ethoxylation. It will also be appreciated that such emulsifiers, whether synthetic or natural, may be used instead of the fatty acid salts described above. Mineral oils may also be incorporated into the compositions, either prior to, during or after dilution; if prior to application to the plant, the TTO-containing compositions are also mixed with the synthetic fungicidal compound or formulation containing the synthetic fungicidal compound, the mineral oil(s) or emulsifier(s) may also be added at this stage.

Thus, in some embodiments, compositions containing TTO and the synthetic fungicidal compound, respectively, will be mixed together and, if necessary, diluted, for application to one or plants. In other embodiments, the TTO and synthetic fungicidal compound may be formulated together, e.g. by methods known in the art or developed in the future, and packaged with appropriate instructions for the end-user. From the description above it will be apparent that compositions containing both TTO and the synthetic fungicidal compound may be made by first making a composition containing TTO and an emulsifier, and then mixing in the synthetic fungicidal compound. It will also be appreciated that another way to prepare compositions containing both TTO and the synthetic fungicidal compound is to mix the TTO into a formulation that already contains the synthetic fungicidal compound, such as an existing commercial formulation. If such formulation already contains a sufficient amount of a suitable emulsifier, then the TTO may be mixed directly with the formulation; if the formulation does not contain a sufficient amount of a suitable emulsifier, then such an emulsifier may be added prior to or concomitantly with the mixing in of the TTO. The resulting formulation, which contains both TTO and the synthetic fungicidal compound, may then be diluted as necessary prior to application to the plant. Alternatively, the formulation may be diluted prior to the mixing in of the TTO. In some cases, it may be possible to dissolve the raw synthetic fungicidal compound in pure TTO or in a TTO-containing composition, and to then formulate this into a desired emulsion by addition of e.g. water and a suitable surfactant, optionally with one or more of a co-surfactant, co-solvent, and other inert ingredient; the emulsion may be suitable for dilution e.g. by tank mixing or may be sufficiently dilute for use on plants. Additionally, as will be appreciated by those skilled in the art, the TTO-containing compositions, whether or not they also contain a synthetic fungicidal compound, may be formulated with adjuvants, such as organosilicates like Silwet 77, clays, talc, acids (such as acetic acid or hydrochloric acid), fatty acid oils, gelatin, resins, gums, polyoxyethylene glycols, sulfated alcohols, fatty acid esters, alkyl sulfonates, petroleum sulfonates, polyol fatty acid esters, polyethoxylated fatty acid esters, aryl alkyl polyoxyethylen glycols, alkyl amine acetates, alkyl aryl sulfonates, alkyl phosphates, and polyhydric alcohols. Such TTO-containing compositions, whether or not they also contain a synthetic fungicidal compound, may also be formulated with preservatives such as 1,2-benzisothiazolin-3-one, and/or with stabilizers such as resins, polyoxyethylene glycols, and gums (e.g. xanthan gum and gum Arabic).

### Example 1

### Vineyard

Various combinations of TTO (supplied as Timorex Gold®, 23.8% TTO) and synthetic fungicidal compositions (supplied as commercial products to be diluted by the end user prior to use, specifically Liquid Copper Fungicide from Southern Agricultural Insecticides, Inc. containing 5-10% copper-ammonium complex and Canon® 50 from Luxembourg Industries Ltd., Israel, containing 780 g potassium phosphite (according to the manufacturer, equivalent to 500 g phosphorous acid per liter were tested against grapevine downy mildew in a mature vineyard in which table grapes of the “Superior” variety were grown. The Timorex Gold or synthetic fungicidal composition were diluted prior to use. At the outset, pre-harvest plants were moderately infected with downy mildew. The crops studied were drip irrigated and fertilized according to known recommendations. Treatments were applied in a randomized complete block, with 4 replications per treatment. Plot size in each instance was 8 m length. Fungicidal treatment was applied using backpack sprayer equipped with a mist blower (STHIL 340 with endpiece 3) to spray a volume of 100 liter/dunam (1000 liter/ha) Foliar sprays were applied on days 1, 10 and 17. The plants were inspected on day 1 (prior to spraying) and days 11, 18 and 24. At the beginning of the experiment, for each group, 5 plant extremities having single leafs were marked. The percent of coverage of downy mildew on a five square cm area was estimated before marking in order to estimate the efficacy in curing infection and after marking to estimate the efficacy in preventing infection. To analyze the results, an arc-sin transformation was performed on the raw data, and analysis of variance (ANOVA) using the SAS GLM procedure was applied to the transformed data. The Tukey-Kramer Test was applied to determine whether differences between treatments were significant. The results are summarized in the tables below. In the tables, “a”, “b” and “c”, refer to differences in statistical analysis that are familiar to users of the Tukey-Kramer test; “SF” is the “synergy” factor, calculated using the Abbott formula (SF=observed efficacy (E_{obs})/expected efficacy (Eₑₓₚ), where Eₑₓₚ=α+β−(αβ/100), where α and β denote the levels of control afforded by materials α and β, respectively, alone; see e.g. Levy et al., EPPO Bull. 16, 651-657 (1986)).

Grape Downy Mildew

| | Seven days after | | | |
|---|---|---|---|---|
| | third application | | | |
| | % infected | | Efficacy | |
| | leaf area | | (%) | SF |
| Curative | | | | |
| Control | 37.75 | a | | |
| TG 0.3% | 29 | b | 23.2 | |
| Potassium phosphite 0.4% | 28.25 | b | 25.2 | |
| Potassium phosphite 0.4% + | 19.5 | c | 48.3 | 1.14 |
| TG 0.3% | | | | |
| Liquid Copper 0.25% | 24.3 | | 35.8 | |
| Liquid Copper 0.25% + | 22.0 | | 41.7 | 0.82 |
| TG 0.3% | | | | |
| Protectant | | | | |
| Control | 33.75 | a | | |
| TG 0.3% | 17.5 | b | 53.6 | |
| Potassium phosphite 0.4% | 14 | b | 62.9 | |
| Potassium phosphite 0.4% + | 7.25 | b | 80.8 | 0.98 |

| | | | |
|---|---|---|---|
| TG 0.3% | | | |
| Liquid Copper 0.25% | 11.5 | 69.5 | |
| Liquid Copper 0.25% + | 9.4 | 75.1 | 0.87 |
| TG 0.3% | | | |

### Example 2

### Cucumber Downy Mildew

Combinations of TTO (supplied as Timorex Gold®, 23.8% TTO) and a synthetic fungicidal composition (supplied Canon® 50 from Luxembourg Industries Ltd., Israel, containing 780 g potassium phosphite (equivalent to 500 g phosphorous acid) per liter) were tested against cucumber downy mildew. Greenhouse-grown plants were drip irrigated and fertilized according to known recommendations for this crop. Treatments were applied in a randomized complete block, with 5 replications per treatment. Plot size in each instance was of 7 m length, containing 14 plants. The TTO or potassium phosphite composition were diluted prior to use. Fungicidal treatment was applied using backpack sprayer equipped with a mist blower (STHIL 340) to spray a at a rate of 350 cc/dunam. Three foliar sprays were applied at 11-13 day intervals. Disease severity was evaluated by determining the leaf area covered with downy mildew (disease severity) on each of 20 leaves randomly selected per each replicate. In addition, the incidence of disease was determined by counting the number of leaves exhibiting mildew colonies on each plant. To analyze the results, an arc-sin transformation was performed on the raw data, and analysis of variance (ANOVA) using the SAS GLM procedure was applied to the transformed data. The Tukey-Kramer Test was applied to determine whether differences between treatments were significant. The results are summarized in the tables below. In the tables, “a”, “b” and “c”, refer to differences in statistical analysis that are familiar to users of the Tukey-Kramer test; “SF” is the “synergy” factor, calculated using the Abbott formula (SF=observed efficacy (E_{obs})/expected efficacy (Eₑₓₚ), where Eₑₓₚ=α+β−(αβ/100), where α and β denote the levels of control afforded by materials α and β, respectively, alone; see e.g. Levy et al., EPPO Bull. 16, 651-657 (1986)).

Cucumber Downy Mildew

| | 11 days after | | | |
|---|---|---|---|---|
| | third application | | | |
| | % infected | | Efficacy | |
| Severity | leaf area | | (%) | SF |
| Control | 17.7 | a | | |
| TG 0.5% | 8.6 | ab | 51.4 | |
| Potassium phosphite 0.4% | 1.4 | b | 92.1 | |
| Potassium phosphite 0.4% + | 0.6 | b | 96.6 | 1.00 |
| TG 0.5% | | | | |
| | Seven days after | | | |
| | third application | | | |
| | % leaves | | Efficacy | |
| Incidence | infected | | (%) | SF |
| Control | 92.5 | a | | |
| TG 0.5% | 73.7 | a | 20.3 | |
| Potassium phosphite 0.4% | 23.7 | bc | 74.4 | |
| Potassium phosphite 0.4% + | 16.2 | c | 82.5 | 1.04 |

TG 0.5%

### Example 3

### Control of Late Blight (Phytophthora infestans) in Potatoes

Potato plants of the “Nicola” cultivar in pre-mixed pot soil, planted in February in a greenhouse in Katzrin, Israel, were used to compare the efficacy of Timorex Gold (TG) alone, a combination of TG with a copper hydroxide product, and a combination of the copper hydroxide product with a Neem tree extract. An artificial infestation of Late blight (Phytophthora infestans) was induced by placing infected and sporulating plants in the greenhouse and providing the appropriate conditions for infestation. Randomised complete blocks containing 4 replicates (2 plants for each replicate) were used. The treatments were applied by hand-spraying to achieve complete cover. Seven applications were made at intervals of 5-9 days, on March 8, 13, 19, 25; April 1, 10, and 18. The crop stage before first application was mature plants before harvest, 0.5 meter high. Efficacy was assessed by evaluating the percentage of infected leaves for each plant and treatment; phytotoxicity was assessed by general observation of the treated and non-treated plants. The test products were as follows:

| Product | Active ingredients (a.i) | Concentration of a.i | | Formulation |
|---|---|---|---|---|
| TG | Tea Tree Oil | 23.8% | w/w | EC |
| KOCIDE | Copper Hydroxide | 538 | g/lit | WP |
| NEEMGARD | An extract of neem-oil | 97% | w/w | OL |

Treatments in the first experiment were as follows:

| Product | Rates as % of Spray Volume | Scope |
|---|---|---|
| TG | 0.5% | efficacy evaluation |
| TG | 0.75% | efficacy evaluation |
| TG | 1.0% | efficacy evaluation |
| NEEMGARD + KOCIDE | 2% + 0.5% | — |
| CONTROL | Untreated | — |

Treatments in the second experiment were as follows:

| Product | Rates as % of Spray Volume | Scope |
|---|---|---|
| BM-608 + KOCIDE | 0.5% + 0.25% | efficacy evaluation |
| BM-608 + KOCIDE | 1.0% + 0.25% | efficacy evaluation |
| NEEMGARD + KOCIDE | 2% + 0.5% | — |
| CONTROL | Untreated | — |

Analysis of variance (ANOVA) using the SAS GLM (SAS Institute, Inc., Cary, N.C.) procedure was applied to data. Least Significant Difference Test (LSD) was used to determine significant differences between treatments.

Results:

| | Late blight (Phytophthora infestans) | | | |
|---|---|---|---|---|
| | 1^{st} assessment | | 2^{ND} ASSESSMENT | |
| | date: April 17 | | DATE: April 29 | |
| | % infected | % product | % infected | % product |
| TEST PRODUCTS | leaf area | efficacy * | leaf area | efficacy * |
| TG 0.5% | 0.4 b | 92.6 | 2.4 b | 73.3 |
| TG 0.75% | 0.4 b | 92.6 | 3.2 b | 64.4 |
| TG 1.0% | 1.0 b | 81.5 | 1.4 b | 84.4 |
| NEEDGARD 2.0% + | 0.0 b | 100 | 1.2 b | 98.6 |
| KOCIDE 0.5% | | | | |
| CONTROL | 5.4 a | — | 9.0 a | — |

* The efficacy of product was calculated by Abbott's formula in relation to the control.

| | Late blight (Phytophthora infestans) | | | | | | | | |
|---|---|---|---|---|---|---|---|---|---|
| | 1^{st} assessment date: 4.17 | | | 2nd assessment date: 4.26 | | | 3^{rd} assessment date: 4.29 | | |
| | % product | | % infected | % product | | % infected | % product | | % infected |
| | efficacy * | | leaf area | efficacy * | | leaf area | efficacy * | | leaf area |
| TG 0.5% + | 0.0 | b | 100 | 0.5 | b | 96.6 | 0.8 | b | 98.1 |
| KOCIDE 0.25% | | | | | | | | | |
| TG 1.0% + | 0.0 | b | 100 | 0.2 | b | 98.6 | 0.5 | b | 98.8 |
| KOCIDE 0.25% | | | | | | | | | |
| NEEDGARD | 0.7 | b | 91.8 | 2.5 | b | 83 | 3.8 | a | 90.9 |
| 2.0% + | | | | | | | | | |
| KOCIDE 0.5% | | | | | | | | | |
| CONTROL | 8.5 | a | — | 14.7 | a | — | 41.7 | a | — |

* The efficacy of product was calculated by Abbott's formula in relation to the control.

TG, the test product, did show any phytotoxic symptoms on the foliage and fruits of the treated Potato plants.

### Example 4

### Treatment of Lettuce Infected with Bremia lactucae

It was found that use of TG in combination with a potassium phosphate product produced significantly better results that using TG alone to treat Bremia lactucae infection in lettuce. Likewise, combinations of TG and azoxystrobin, thiophanate methyl and pyraclostrobin were found to yield better results than the use of TG alone to treat Bremia lactucae infection in lettuce.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the general combination of parts that perform the same functions as exemplified in the embodiments, and includes both combinations and sub-combinations of the various features described hereinabove as well as variations and modifications thereof, which would occur to persons skilled in the art upon reading the foregoing description.

1. A method for treating a plant infection caused by a member of the class oomycetes, comprising applying to the plant a combination of tea tree oil (TTO) and a synthetic fungicidal compound.

2. The method according to claim 1, wherein the infection is caused by a member of the group consisting of Phytophthora, Pseudoperonospora, Peronospora, Plasmopara and Pythium.

3. The method according to claim 1, wherein the infection is caused by an oomycete selected from the group consisting of Pseudoperonospora cubensis (cucumber downy mildew) Plasmopara viticola (grapevine downy mildew), Bremia lactucae (lettuce downy mildew), Peronospora destructor (onion downy mildew), Peronospora viciae (pea downy mildew), Phytophthora infestans (potato blight), and Phytophthora capsici.

4. The method according to claim 3, wherein the infection is selected from the group consisting of cucumber downy mildew and grapevine downy mildew.

5. The method according to claim 1 wherein the combination is applied to the leaves of the plant.

6. The method according to claim 1, wherein the TTO is applied as a TTO-containing composition.

7. The method according to claim 6 wherein the TTO-containing composition comprises TTO and an emulsifier.

8. The method according to claim 7 wherein the emulsifier is (a) an alkali metal salt of a C₆-C₂₆ fatty acid, an ammonium salt of a C₆-C₂₆ fatty acid, or a mixture of such salts, or (b) selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates.

9. The method according to claim 8 wherein the TTO-containing composition is an oil-in-water emulsion.

10. The method of claim 9 wherein the TTO is present in the TTO-containing composition in an amount of from 0.01 wt. % to 10 wt. %.

11. The method of claim 10 wherein the TTO-containing composition further comprises the synthetic fungicidal compound.

12. The method of claim 11 wherein the combination is applied simultaneously.

13. The method of claim 12 wherein the combination is applied as a single mixture.

14. The method of claim 13 wherein at least one of the following is true (a) the synthetic fungicidal compound is applied at a dosage rate that is less than the rate indicated by the manufacturer as being the correct dosage rate in the absence of TTO; (b) the TTO is applied at a dosage rate that is less than the rate indicated by the manufacturer as the rate used when the TTO is applied in the absence of a synthetic fungicidal compound.

15. The method of claim 14 wherein the dosage rate at which the synthetic fungicidal compound is applied is (a) not greater than 95% of the correct dosage rate as indicated by the manufacturer in the absence of TTO and (b) at least 40% of the correct dosage rate as indicated by the manufacturer in the absence of TTO.

16. The method of claim 15 wherein the dosage rate at which the TTO is applied is (a) not greater than 95% of the correct dosage rate as indicated by the manufacturer in the absence of application of a synthetic fungicidal compound and (b) at least 40% of the correct dosage rate as indicated by the manufacturer in the absence of application of a synthetic fungicidal compound.

17. The method of claim 14 wherein the synthetic fungicidal compound is selected from the group consisting of (a) PhenylAmides (PAs), (b) Quinone outside inhibitors (QoIs), (c) Polyoxins, (d) Cyanoacetamide oximes, (e) Phosphonates, (f) demethylation inhibitors (DMIs), (g) Carboxylic Acid Amides (CAAs), (h) Cyanoacetamide-oxime; (i) Dithiocarbamates, (j) Benzamides, (k) 2,6-Dinitroanilines, (l) Carbamates, (m) Quinone inside Inhibitors (QiIs), (n) Chloronitriles, (o) copper-based products, and (p) organotin compounds.

18. The method of claim 17 wherein the synthetic fungicidal compound is selected from the group consisting of (a) a phenylamide selected from the group consisting of benalaxyl, benalaxyl-M, furalaxyl, metalaxyl, oxadixyl and metalaxyl-M, (b) a Quinone outside Inhibitor selected from the group consisting of famoxadone, azoxystrobin, pyraclostrobin, trifloxystrobin, fluoxastrobin, and fenamidone, (c) a Cyanoacetamide oxime which is cymoxanil, (d) a phosphonate which is potassium phosphite or ammonium phosphite, (e) a demethylation inhibitor (DMI) which is difenoconazole, (f) a carboxylic acid amide (CAA) which is dimethomorph or mandipropamid, (g) a dithiocarbamate which is mancozeb, (h) a benzamide which is zoxamide, (i) a 2,6-dinitroaniline which is fluazinam, (j) a carbamate which is propamocarb, (k) a quinone inside inhibitor (QiI) which is cyazofamid, (l) a chloronitrile which is chlorothalonil, (m) an organotin compound which is triphenyltin hydroxide.

19. The method of claim 17 wherein at least one of the following is true: (a) the synthetic fungicidal compound is a compound that is indicated for the treatment of cucumber downy mildew, and the combination is applied to at least one cucumber plant; (b) the synthetic fungicidal compound is a compound that is indicated for the treatment of grapevine downy mildew and the combination is applied to at least one grapevine.

20. A composition comprising tea tree oil (TTO) and at least one synthetic fungicidal compound that is active against a fungus of the class oomycetes and is not active against fungi of the class ascomycetes.

21-349. (canceled)
